(19) United States
(12) Patent Application Publication
(10) Pub. No.: US 2014/0198819 A1
(43) Pub. Date: Jul. 17, 2014

(54) METHOD OF RECOVERING ENERGY FROM AN ELECTRIC INDUCTION FURNACE EXHAUST GAS IN THE GASIFICATION OF FEED FUEL TO EXHAUST GAS

(71) Applicant: How Kiap Gueh, Singapore (SG)

(72) Inventor: How Kiap Gueh, Singapore (SG)

(21) Appl. No.: 14/155,900

(22) Filed: Jan. 15, 2014

(30) Foreign Application Priority Data
Jan. 15, 2013 (SG) 201300318-1

(51) Int. Cl. F27D 7/06; F27D 11/06

(52) U.S. Cl. CPC F27D 7/06; F27D 11/06
USPC 373/8

(57) ABSTRACT

A method of recovering energy from an electric induction furnace exhaust gas in the gasification of feed fuel to exhaust gas. Melt of an electrically conductive material, which is disposed within electric induction furnace, is pressurized while substantially sealing the electric induction furnace to enable the build-up of a superatmospheric pressure in said furnace. A feed fuel is injected into contact with at least a portion of the melt of electrically conductive material. Exhaust gas generated at a superatmospheric pressure is withdrawn from said furnace and scrubbed and stored for subsequent use in a gas accumulator. The total calorific value of the exhaust gas from the gas accumulator that is available for use by a gas consumer device is measured and estimated. An input of feed fuel, of auxiliary gases and of heating power to the electric induction furnace is adjusted such that the estimated total calorific value of exhaust gas is kept between a pre-determined upper and a pre-determined lower threshold by using an adjustable controller unit that comprises a PD controller. A gas consumer device is fed with the exhaust gas from the accumulator independently of the blowing periods. The electric induction furnace exhaust gas is maintained under superatmospheric pressure during the blowing, withdrawing, scrubbing and storing steps without recompression.

### CROSS-REFERENCE TO RELATED APPLICATIONS

This application claims priority to Singapore Application No. 201300318-1, filed Jan. 15, 2013, the entire disclosure of which is incorporated by reference herein.

### BACKGROUND

Gasification is a process in which combustible materials are partially oxidized or partially combusted. The product of gasification is a combustible synthesis gas, or syngas.

In 1912-13, Frederick Bergius described the fundamental process for hydrogenating coal under very high pressure to yield liquid fuels. (Bergius was awarded a one-half share of the 1931 Nobel Prize in chemistry for this work. Carl Bosch, a titan of the German chemical field, was awarded the other half.) Bergius' “direct liquefaction” of coal was used to produce liquid fuels in Germany during both world wars. A decade after Bergius' work, Franz Fischer and Hans Tropsch, while at the Kaiser Wilhelm Institute, developed the chemistry that now bears their names, and is sometimes referred to as “indirect liquefaction.” The general Fischer-Tropsch synthesis is a metal-catalyzed reaction to produce liquid hydrocarbons from a feedstock comprising hydrogen and carbon monoxide. The feedstock is universally referred to as synthesis gas, or simply “syngas.” The syngas itself is derived from the partial combustion of methane or from the gasification of coal or other biomass.

The general reactions are as follows:

CH4+½O2→2H2+CO

(2n+1)H2+nCO→CnH2n+2+nH2O

The worldwide depression of the 1930's placed a severe economic strain on German companies' early efforts to build large-scale coal gasification plants. As the depression lingered on, crude oil prices plunged to 10 cents per barrel, resulting in a worldwide glut of cheap oil. Two developments, however, stemmed the collapse of the nascent goal gasification industry: (1) the rise of the Nazi government; and (2) the consolidation of the entire German chemical enterprise into an enormous, centrally-organized cartel (I. G. Farben). Begun in 1925, the formation and growth of I. G. Farben and its influence on the development of coal gasification technology can hardly be understated. Underwritten by the Nazi government, and backed by the full might of Germany's preeminent chemical and industrial prowess, German efforts to convert its coal riches into liquid fuel continued unabated throughout the 1930's.

These efforts were vastly expanded during the years of World War II (1939-1945), as Germany was increasingly denied access to sources of crude oil. Synthetic liquid fuels produced from coal gasification accounted for roughly half of Germany's total production of fuel near the end of the war—124,000 barrels per day from 25 plants at its peak near the end of 1944. At that point, synthetic fuel accounted for 92% of Germany's aviation gasoline. (Intense allied bombing of German synthetic fuel plants began in earnest in late 1944 and early 1945. The results were immediate and fatal for the German war machine. In February 1945, Nazi Germany produced roughly a thousand tons of synthetic aviation gasoline—about one half of one percent of the level of the first four months of 1944. Hostilities in Europe ceased in May of 1945.) See U.S. Department of Energy, “The Early Days of Coal Research.”

After World War II, efforts to gasify coal and biomass stagnated as huge reserves of crude oil were discovered and exploited in the Middle East, Venezuela, Nigeria, and elsewhere. The formation of another cartel, the Organization of Petroleum Exporting Countries (OPEC), and its exercise of pricing power in crude oil markets rejuvenated the coal and biomass gasification field. Founded in 1960 by Iran, Iraq, Kuwait, Saudi Arabia and Venezuela (and later joined by Qatar, Indonesia, Libya, UAE, Algeria, Nigeria and Angola), OPEC did not rise to prominence until 1973, when the Arab members of OPEC instituted an oil embargo that sent crude oil prices skyrocketing. The Islamic fundamentalist revolution in Iran in 1979 sent crude oil prices briefly into the stratosphere ($100 per barrel when adjusted for inflation to January 2007). The mid-1980's, however, saw an equally dramatic drop in oil prices from their 1979 highs. Continued political instability in the middle east starting with the 1991 Gulf War, and extending to the panic caused by the Sep. 11, 2001 terrorist attacks in the U.S. (and the subsequent U.S. invasion and occupation of Iraq), coupled with the rapid industrialization of China and India, have combined to maintain current crude oil prices at very high levels.

Gasification technology has, for example, been actually utilized in a power plant integrated with coal gasification units, etc, with being oxygen or highly oxygen-enriched air is supplied to a coal gasification plant as a gasifying agent. However, consumption of the generated electric power in an auxiliary facility including an oxygen plant for producing such a gasifying agent is highly energy intensive. The gasification reaction typically involves delivering feed, free-oxygen-containing gas and any other materials to a gasification reactor which is also referred to as a “partial oxidation gasifier reactor” or simply a “reactor” or “gasifier.” Because of the high temperatures utilized, the gasifier is lined with a refractory material designed to withstand the reaction temperature. The feed and oxygen are intimately mixed and reacted in the gasifier to form syngas. While the reaction will occur over a wide range of temperatures, the reaction temperature which is utilized must be high enough to melt any metals which may be in the feed. If the temperature is not high enough, the outlet of the reactor may become blocked with unmelted metals. On the other hand, the temperature must be low enough so that the refractory materials lining the reactor are not damaged.

Gasifiers may be classified according to (a) the BTU content of the fuel gas, (b) the temperature at which gasifier operates, and (c) the type of gasification reactor used (i.e., fixed, fluidized, entrained bed, molten metal bed, etc).

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value. In some instances, the term about can denote a value within a range of ±10% of the quoted value.

The indefinite articles “a” and “an” as used herein mean one or more when applied to any feature in embodiments of the present specification described in the specification and claims. The use of “a” and “an” does not limit the meaning to a single feature unless such a limit is specifically stated. The definite article “the” preceding singular or plural nouns or noun phrases denotes a particular specified feature or particular specified features and may have a singular or plural connotation depending upon the context in which it is used. The adjective “any” means one, some, or all indiscriminately of whatever quantity. The term “and/or” placed between a first entity and a second entity means one of (1) the first entity, (2) the second entity, and (3) the first entity and the second entity.

Terms “heating value,” “calorific value,” “caloric value,” are interchangeably used within this description.

Feed, or feed fuel as used herein throughout the specification and claims, may refer to coal, biomass, municipal solid waste, refuse-derived fuel (RDF), industrial waste, sewage, raw sewage, peat, scrap rubber, shale ore, tar sands, crude oil, natural gas, low-BTU blast furnace off-gas, flue gas exhaust (flue gas generated from the combustion of fossil fuel in a fossil fuel boiler, or flue gas generated from the combustion of a internal combustion engine unit, or a combination thereof), or a combination thereof, this is applicable for instances where a device according to the present specification is utilized as a gasification system, and in some other applications such as metallurgical smelting of metals, melting, heating or alloying of metals, feed may additionally refer to metal material, coal, flux agents such as CaO powder, or a combination of the feeds described and used for the gasification system previously described.

Refuse-derived fuel (RDF), which is generally produced by shredding municipal solid waste, consists largely of organic components of municipal waste such as plastics and biodegradable waste. Non-combustible materials such as glass and metals are removed mechanically and the resultant material compressed into pellets, bricks, or logs and used for conversion to combustible gas, which can itself be used for electricity generation or the like.

Coal refers to a common fossil fuel, the most common classification is based on the calorific value and composition of the coal. Coal is of importance as a fuel for power generation now and in the future since there are a lot of coal reserves, and the coal reserves are hardly unevenly distributed over the world.

ASTM (American Society for Testing and Materials) standard D388 classifies the coals by rank. This is based on properties such as fixed carbon content, volatile matter content, calorific value and agglomerating character. Broadly, the coals can be categorized as “high rank coal” and “low rank coal,” which denote high-heating-value, lower ash content and lower heating value, higher ash content coals, respectively. Low-rank coals include lignite and sub-bituminous coals. These coals have lower energy content and higher moisture levels. High-rank coals, including bituminous and anthracite coals, contain more carbon than lower-rank coals and correspondingly have a much higher energy content. Some coals with intermediate properties may be termed as “medium rank coal.”

The term biomass covers a broad range of materials that offer themselves as fuels or raw materials and are characterized by the fact that they are derived from recently living organisms (plants and animals). This definition clearly excludes traditional fossil fuels, since although they are also derived from plant (coal) or animal (oil and gas) life, it has taken millions of years to convert them to their current form. Thus the term biomass includes feeds derived from material such as wood, woodchips, sawdust, bark, seeds, straw, grass, and the like, from naturally occurring plants or purpose grown energy crops.

It includes agricultural and forestry wastes. Agricultural residue and energy crops may further include husks such as rice husk, coffee husk etc., maize, corn stover, oilseeds, cellulosic fibers like coconut, jute, and the like. Agricultural residue also includes material obtained from agro-processing industries such as deoiled residue, gums from oil processing industry, bagasse from sugar processing industry, cotton gin trash and the like. It also includes other wastes from such industries such as coconut shell, almond shell, walnut shell, sunflower shell, and the like.

In addition to these wastes from agro industries, biomass may also include wastes from animals and humans. In some embodiments, the biomass includes municipal waste or yard waste, sewage sludge and the like. In some other embodiments, the term biomass includes animal farming byproducts such as piggery waste or chicken litter. The term biomass may also include algae, microalgae, and the like. Thus, biomass covers a wide range of material, characterized by the fact that they are derived from recently living plants and animals. All of these types of biomass contain carbon, hydrogen and oxygen, similar to many hydrocarbon fuels; thus the biomass can be used to generate energy. Common sources of biomass include (without limitation): (1) agricultural wastes, such as corn stalks, straw, seed hulls, sugarcane leavings, bagasse, nutshells, and manure from cattle, poultry, and hogs; (2) woody materials, such as wood or bark, sawdust, timber slash, and mill scrap; (3) municipal waste, such as waste paper and yard clippings; (4) energy crops, such as poplars, willows, switch grass, alfalfa, prairie bluestem, corn, soybean, and (5) coal, peat moss, and the like.

In at least one specific embodiment the feed fuel can be suspended, slurried or otherwise conveyed by the carrier fluid and gasified in the gasification zone within the molten material disposed within metallic crucible according to the present specification to provide a syngas containing hydrogen, carbon monoxide, and carbon dioxide. At least a portion of the syngas can be used to produce electrical power, hydrogen, and/or commodity chemicals such as Fischer-Tropsch (“F-T”) products, hydrogen, carbon monoxide and/or carbon dioxide.

Fischer-Tropsch (“F-T”) products, include refinery/petrochemical feedstocks, transportation fuels, synthetic crude oil, liquid fuels, lubricants, alpha olefins, waxes, and the like. The F-T reaction can be carried out in any type reactor, for example, through the use of fixed beds; moving beds; fluidized beds; slurries; bubbling beds, or any combination thereof. The F-T reaction can employ one or more catalysts including, but not limited to, copper-based; ruthenium-based; iron-based; cobalt-based; mixtures thereof, or any combination thereof. The F-T reaction can be carried out at temperatures ranging from about 190° C. (374° F.) to about 450° C. (842° F.) depending on the reactor configuration. Additional reaction and catalyst details can be found in U.S. 2005/0284797 and U.S. Pat. Nos. 5,621,155; 6,682,711; 6,331,575; 6,313,062; 6,284, 807; 6,136,868; 4,568663; 4,663,305; 5,348,982; 6,319,960; 6,124,367; 6,087,405; 5,945,459; 4,992,406; 6,117,814; 5,545,674, and 6,300,268.

Fischer-Tropsch products including liquids which can be further reacted and/or upgraded to a variety of finished hydrocarbon products. Certain products, e.g. C4-C5 hydrocarbons, can include high quality paraffin solvents which, if desired, can be hydrotreated to remove olefinic impurities, or employed without hydrotreating to produce a wide variety of wax products. Liquid hydrocarbon products, containing C16 and higher hydrocarbons can be upgraded by various hydroconversion reactions, for example, hydrocracking, hydroisomerization, catalytic dewaxing, isodewaxing, or combinations thereof. The converted C16 and higher hydrocarbons can be used in the production of mid-distillates, diesel fuel, jet fuel, isoparaffinic solvents, lubricants, drilling oils suitable for use in drilling muds, technical and medicinal grade white oil, chemical raw materials, and various hydrocarbon specialty products.

Commodity chemicals including, but not limited to, acetic acid, phosgene, isocyanates, formic acid, propionic acid, mixtures thereof, derivatives thereof, and/or combinations thereof, ammonia, using the Haber-Bosch process described in LeBlanc et al in “Ammonia,” Kirk-Othmer Encyclopedia of Chemical Technology, Volume 2, 3rd Edition, 1978, pp., 494-500. In one or more embodiments, synthesis gas, or commodity chemicals or F-T products or a combination thereof can be used for the production of alkyl-formates, for example, the production of methyl formate. Any of several alkyl-formate production processes can be used, for example a gas or liquid phase reaction between carbon monoxide and methanol occurring in the presence of an alkaline, or alkaline earth metal methoxide catalyst. Additional details can be found in U.S. Pat. Nos. 3,716,619; 3,816,513; and 4,216,339.

In one or more embodiments, a reaction device can be used to produce methanol, dimethyl ether, ammonia, acetic anhydride, acetic acid, methyl acetate, acetate esters, vinyl acetate and polymers, ketenes, formaldehyde, dimethyl ether, olefins, derivatives thereof, or combinations thereof. For methanol production, for example, the Liquid Phase Methanol Process can be used (LPMeOH™). In this process, at least a portion of the carbon monoxide in the syngas can be directly converted into methanol using a slurry bubble column reactor and catalyst in an inert hydrocarbon oil reaction medium. The inert hydrocarbon oil reaction medium can conserve heat of reaction while idling during off-peak periods for a substantial amount of time while maintaining good catalyst activity.

Additional details can be found in U.S. 2006/0149423 and prior published Heydorn, E. C., Street, B. T., and Kornosky, R. M., “Liquid Phase Methanol (LPMeOH™) Project Operational Experience,” (Presented at the Gasification Technology Council Meeting in San Francisco on Oct. 4-7, 1998). Gas phase processes for producing methanol can also be used. For example, known processes using copper based catalysts, the Imperial Chemical Industries process, the Lurgi process and the Mitsubishi process can be used.

In one or more embodiments, the hydrogen-rich product can be used in one or more downstream operations, including, but not limited to, hydrogenation processes, fuel cell energy processes, ammonia production, and/or hydrogen fuel. For example, the hydrogen-rich product can be used to make hydrogen fuel using one or more hydrogen fuel cells. In one or more embodiments, at least a portion of the syngas can be combined with one or more oxidants and combusted in one or more combustors to provide a high pressure/high temperature exhaust gas. The exhaust gas can be passed through one or more turbines and/or heat recovery devices to provide mechanical power, electrical power and/or steam. In one or more embodiments, the exhaust gas can be introduced to one or more gas turbines to provide an exhaust gas and mechanical shaft power to drive the one or more electric generators. In one or more embodiments, the exhaust gas can be introduced to one or more heat recovery systems to provide steam. In one or more embodiments, a first portion of the steam can be introduced to one or more steam turbines to provide mechanical shaft power to drive one or more electric generators. In one or more embodiments, a second portion of the steam can be introduced to the gasifier, and/or other auxiliary process equipment. In one or more embodiments, lower pressure steam from the one or more steam turbines can be recycled to the one or more heat recovery systems. In one or more embodiments, residual heat can be rejected to a condensation system well known to those skilled in the art or sold to local industrial and/or commercial steam consumers.

The term “containerized” defines a configuration wherein a self-contained gasifier system (electric induction furnace set) is installed in one or more containers. A containerized molten metal gasifier system may be transportable, i.e., it may be adapted for transportation by truck, train, barge, ship, or airplane as one or more modular containers. These containers may comprise, for example, one or more standard ISO shipping containers. ISO shipping containers are available world-wide at reasonable cost. Standard ISO containers have lengths of 20 ft (6.1 m), 40 ft (12.2 m), 45 ft (13.7 m), 48 ft (14.6 m), and 53 ft (16.2 m). The standard 20, 40, 48, and 53 ft containers have an external width of 8 ft, an external height of 8 ft 6 in, an internal width of 7 ft 8⅝ in, and an internal height of 7 ft 9⅞ in. The 45 ft container is a “high-cube” container having an external height of 9 ft 6 in. The 20 ft container is the most common container worldwide, but the 40 ft container is increasingly replacing it, particularly since costs tend to be per container and not per unit of container length. The longer container types are also becoming more common, especially in North America. ISO containers are designed for standardized transportation on trucks, ships, and trains, and the containers also may be shipped conveniently by barge and airplane.

Raw product syngas (raw synthetic fuel gases, or fuel gas) produced by most commercial fuel gasifiers and gasifiers now under development contains various concentrations of coal tar, polycyclic aromatic hydrocarbons, and soot. These can cause serious operational problems in heat recovery and gas cleaning, but more importantly, they represent a serious environmental hazard. Many of the polycyclic aromatic compounds found in raw synthetic fuel gases are either direct or latent carcinogens.

The current approach to removing these compounds from the fuel gas involves adding gas cleaning systems to the coal gasifiers to remove the contaminants present in the fuel gas, including coal tar, polycyclic aromatic hydrocarbons, and soot. There are two types of gas cleaning systems currently in use or under consideration. In “cold gas cleaning,” the raw fuel gas is cooled either by direct contact with water in a spray tower or in a scrubber, or by heat exchanger with the clean fuel gas in a high temperature heat exchanger. After cooling, the gas is cleaned to remove tar, polycyclic aromatic hydrocarbons, particulates, sulfur compounds, ammonia, and trace contaminants. In “hot gas cleaning,” an attempt is made to remove particulate matter, sulfur compounds (e.g., H2 S, COS), and trace contaminants (e.g., NH3, alkali metals, etc.), at high temperature (e.g. about 1600° F.).

In cold gas cleaning, coal tar and polycyclic aromatic hydrocarbons are condensed on particulate matter and enter waste water streams. If coal gasifiers employing “cold gas” cleaning systems are operated on a large scale, huge quantities of solid wastes and waste water, contaminated by polycyclic aromatic hydrocarbons will be generated. The safe disposal of these wastes constitutes an environmental problem of major proportion.

### SUMMARY

In accordance with the present specification, in a method of recovering energy from the exhaust gases of an electric induction furnace and/or a method of operating a electric induction furnace for the recovery of energy therefrom wherein the gasification and energy recovery process is carried out in a substantially sealed and closed blowing electric induction furnace operated at a superatmospheric pressure, i.e. a pressure within the electric induction furnace from one to several atmospheres absolute, or from somewhat more than one PSIA up to about 40 PSIA.

According to an essential feature of the method aspects of the present specification, the electric induction furnace exhaust gases under pressure from the electric induction furnace are subjected to a wet-washing or scrubbing and the scrubbed exhaust gas is stored in a gas-storage vessel or accumulator under pressure and is withdrawn from the latter to operate an energy-producing gas consumer device independently of the blowing period and in dependence upon the operation of the gas consumer device.

The term “blowing process” or its derivatives is used herein to mean that air is injected into contact with an electrically conductive material disposed within electric induction furnace. The term “independent from the blowing process” is used herein to mean that the energy is available even between blowing processes from the accumulator whether or not the gas consumer device may be turned on or off.

The term “exhaust gas” means synthesis gas having CO, H.sub.2, CO2 gases or combinations thereof.

When, in accordance with a preferred embodiment of the present specification, the process is carried out with the resultant exhaust gas sufficient to combust at least a portion of this exhaust gas and drive a gas turbine or a reciprocating engine set with the combustion product. Alternatively or in addition, the exhaust gas can drive an expansion turbine and thereafter can be supplied to a boiler for waste heat recovery.

### BRIEF DESCRIPTION OF THE DRAWING

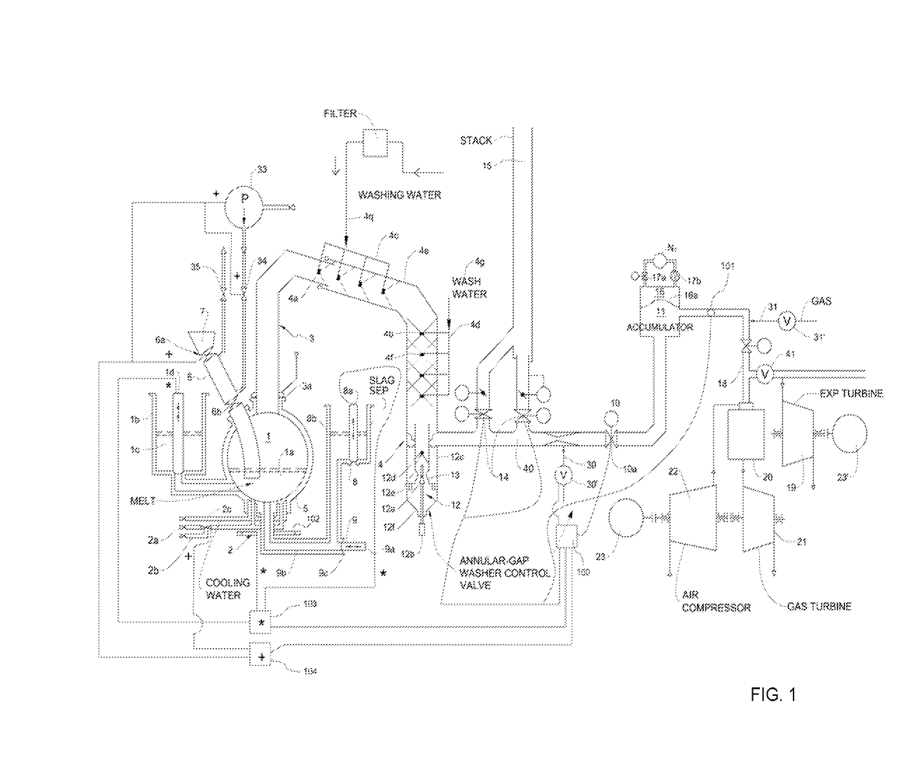

The above and other objects, features and advantages of the present specification will become more readily apparent from the following description, reference being made to the accompanying drawing in which FIG. 1 is a flow diagram of a complete turn-key plant for carrying out the present specification in practice.

### DETAILED DESCRIPTION

The drawing illustrates one embodiment for carrying out the present specification in practice.

The apparatus shown in the drawing comprises a substantially sealed and closed electric induction furnace 1 shown diagrammatically and which is provided with a bottom-blowing air supply system represented at 2 for blowing the electrically conductive material 1a disposed within the electric induction furnace with a blowing gas which can be introduced through a pipe 2a. The blowing gas is air. A pipe 2b can add other desirable components to the blowing gas while a cooling-water line 2c provides water to jacket the blowing tubes of the blowing device generally represented at 2. The electric induction furnace 1 comprises an induction coil 102 which is provided with an adjustable induction control unit that is not shown here.

The level of the electrically conductive material 1a in the converter can be controlled by a receptacle 1b connected to the electric induction furnace below the surface of the electrically conductive material and containing a quantity 1c of the molten metal. A stopper 1d controls transfer of the molten metal between the converter and the receptacle 1b.

The electric induction furnace 1 is provided with an exhaust gas stack generally represented at 3 and connected through the electric induction furnace by a gas pressure gate 3a preventing escape of gases from the electric induction furnace under the superatmospheric pressure at which the latter is operated.

The feed fuel is introduced into the electric induction furnace via a hopper 7 and a charging pressure gate 6 which can have a pair of valves 6a and 6b which can be alternately opened to admit the feed fuel from the hopper 6 to the space between the valves 6a and 6b whereupon valve 6a is closed and valve 6b is opened to permit the charge to enter the electric induction furnace.

The feed fuel is pre-sized a approximate sieve size of between 0.5 and 1.5 mesh, which is equivalent to about 12.5 mm to 37.5 mm, about 25 mm. 1 Mesh is 1 strand per inch, and one must take the wire thickness of the strands into account.

To prevent escape of gas and to maintain the pressure in the electric induction furnace, a pump 33 supplies gas under pressure via the valve 34 to the gate 6, the excess gas is vented at a venting outlet 35. The exhaust gas stack 3 forms a duct provided with an initial scrubbing system represented diagrammatically at 4. More particularly, the stack is divided into a downwardly extending portion 4e and an upright portion 4f. The downwardly extending portion 4e is provided with a group of spaced apart spray nozzles 4a connected by a manifold 4c to a source 4g of the wash water.

In another portion of the stack or duct, i.e. the upright portion 4f of the stack, is provided another array of nozzles 4b connected to the manifold 4d which is supplied with the scrubbing water.

Downstream of the scrubbing unit 4 there is provided a regulating valve 12 in the form of an annular-gap washer 13. As described in the aforementioned publication, the annular-gap washer can include a cylindrical duct 12c which can be provided with still another scrubbing nozzle 12d and through which the gas is caused to flow. The cylindrical duct 12c terminates at its lower end in a Venturi nozzle 12e, the latter being of the convergent-divergent type, the divergent section receiving a generally conical body 12a which can be displaced on a rod 12f by a servomotor 12d to control the pressure.

From this annular-gap washer 13, the gas is passed upwardly and thence through a duct 40. Pressure-control valves 14 permit bleeding of excess gas to a flaring stack 15 in which the exhaust gas is flared off.

An inlet 30 provided with a valve 30′ can supply a second flow stream of exhaust gas from a remote site such as a second electric induction furnace set (not shown) to the exhaust gas in the duct 40 before the exhaust gas enters the gas accumulator 11 via the connecting duct 10 and a pressure control valve 10a. The gas accumulator 11 can be formed with a flexible membrane 16a so that the compressed gas in the compartment 16, e.g. nitrogen, will not mix with the washed and scrubbed exhaust gas from the converter.

A nitrogen source 17 connected by a pressure control valve 17a and a throttle valve 17b with the chamber 16 of the accumulator to pressurize the latter and drive the exhaust gas to the energy utilization stage. A duct 18 leads from the gas accumulator 11 and is provided with an inlet 31 having a valve 31′ for second flow stream of exhaust gas used to augment the heat value of the exhaust gas. A valve 41 controls the quantity of the exhaust gas which is bled to an expansion turbine driving the generator 23′ in the manner described in the aforementioned publication. Second flow stream of exhaust gas may be of similar chemical composition as the original exhaust gas or may have its CO, H.sub.2 or both gas content adjusted prior to introduction to inlet 31. The exhaust gas, can be introduced into a combustion chamber 20 to which air is supplied by a compressor 22 to facilitate combustion of the exhaust gas in the combustion chamber.

The compressor 22 is, in turn, driven by a gas turbine 21 powered by the high velocity gases emerging from the combustion chamber. An electrical generator 23 is coupled to the shafts of the turbine 21 (so as to be driven thereby) and the compressor 22. Both generators 23 and 23′ can be connected to a single network.

From the aforegoing it will be apparent that the electric induction furnace set of the present specification includes an electric induction furnace unit with a device 2 for the blowing of fresh gas through the melt (bottom-blowing nozzles), an exhaust gas stack 3 and a washing device 4 for the converter exhaust gases.

According to the present specification, however, the electric induction furnace is formed as a substantially sealed or closed reaction vessel with a gate 6 for introducing the feed fuel from the hopper 7. The electric induction furnace is also provided with a slag-removal device represented generally at 8 and a melt recovery device represented generally at 9 to recover at least a portion of the electrically conductive material disposed within electric induction furnace reaction vessel. The slag removal device 8 comprises an upright cylinder 8b communicating from above with the top of the duct 9b leading to the charge tap 9c which can be selectively blocked or unblocked whenever the electrically conductive material is to be recovered or tapping of the electric induction furnace is desirable for some other purpose. The slag separator consists of an upright vessel 8b in which a plug 8a is displaceable.

The system also includes an exhaust gas stack 3 having an integrated wet-washing or scrubbing installation and connected to the reaction vessel 5. A connecting duct 10 connects the scrubbing units to the gas accumulator 11. In the wet-washing or scrubbing units 4 and/or in the connecting duct between the scrubbing device 4 and the gas accumulator 11, there is provided at least one regulating valve 12 which enables the pressure to build up behind the valve and hence in the electric induction furnace. It has already been mentioned that the scrubbing device 4 includes the annular-gap washer, e.g. of the aforementioned publication, serving simultaneously as the control valve or regulating valve 12. It is within the framework of the present specification to provide pressure-retaining valves 14 which enable the flaring chimney to operate efficiently, i.e. burnoff of gas.

The stack 13 is also useful when the gas supplied exceeds that which can be successively stored in the accumulator 11 in above or underground storage. The apparatus aspects of the present specification involve the provision of the gas accumulator 11 with a volume such that it is capable of storing the exhaust gases generated over a determined time period.

The accumulator 11 stores the scrubbed exhaust gas in force-transmitting relationship with a nitrogen cushion operated by the nitrogen storage source 17. The gas is separated from the nitrogen by a flexible impermeable membrane. The gas can be continuously withdrawn from the accumulator 11. The gas withdrawn from the accumulator 11 is fed via line 18 to the gas consumer device. In the gas consumer device, at least part of the gas is burned, e.g. for recovery of energy in a boiler. Note that the term gas consumer device means a downstream set of equipment or plant or both.

The embodiment comprises measuring and estimating the total calorific value of the exhaust gas from the accumulator 11, wherein the volume stream of the injected feed fuel is adjusted such that the estimated total calorific value of exhaust gas is kept between a pre-determined upper and a pre-determined lower threshold. Measuring the total calorific value of the exhaust gas behind the accumulator 11 provides a stable control with a simple PD controller and without a PID controller, as opposed to an arrangement in which the total calorific value of the exhaust gas is measured before the accumulator 11.

A calorific value sensor device 101 is provided as gas concentration meter based on online spectrum analysis or—in addition or as an alternative—as a combustion meter, separating a small stream of exhaust gas out from the accumulator 11 and burning it under a controlled environment.

An adjustable controller unit 100 reads in the value from the calorific value sensor device 101 and applies ad-hoc control interventions to control components of the induction furnace and its supply elements, such as the valve 6a, the stopper 1d of the molten melt reservoir 1b, the plug 8a, the pump 33, the valve 34, the valves in the pipes 2a and 2b, the control device of the induction coil 102, the valves 14, the pressure control valve 10a, and the valve 30′. In a very simple embodiment, the adjustable controller unit 100 is provided as a simple PD controller, and not as a PID controller, which means that the integral component is constantly zero.

The adjustable controller unit 100 acts as a master control unit which can either directly control the respective electric actuators of the above mentioned control units or—as an alternative—provide a guidance value for a separate control circuit which controls the respective actuator. In a further embodiment, the controls of the stopper 1d of the molten melt reservoir 1b, of the plug 8a, and of the induction coil 102 are combined into a heating control unit 103 in the form of a PID controller, while the controls of the respective feeds into the receptacle 1b, such as of the valve 6a, of the pump 33, of the valve 34, and of the valves in the pipes 2a and 2b are combined into a feed control unit 104 in the form of a PID controller. The control of the electric actuators of the valves 14, of the pressure control valve 10a, and of the valve 30′ is provided as a direct control by the adjustable controller unit 100. For reasons of clarity, outputs and corresponding inputs of the heating control unit 103 are marked by an asterisk “*” and outputs and corresponding inputs of the feed control unit 104 are marked by a plus sign “+” in FIG. 1.

In an embodiment with a very simple structure, the adjustable controller unit 100 is provided as a PD controller. The location of the calorific value sensor device 100 is provided behind the accumulator 11, and not before the accumulator 11 as seen with respect to the fluid stream through the accumulator 11.

The control strategy is such that the adjustable controller unit 100 seeks first to actuate the electric actuators of the valves 14, of the pressure control valve 10a, and of the valve 30′if there are short-term ad-hoc adjustments necessary. Mid- and long-term adjustments are assigned to the heating control unit and to the feed control unit.

In the case of the measured calorific value exceeding a pre-determined threshold value, the adjustable controller unit 100 would first open the valves 14 to the stack 15 and/or close the valve 30′. If this action does not sufficiently reduce the measured calorific value, corresponding commands to decrease the supply of exhaust gas are given to the heating control unit and to the feed control unit, which are also communicating with each other for avoiding an overheating and/or underheating of the electrically conductive material.

In the case of the measured calorific value falling below a second pre-determined threshold value, the adjustable controller unit 100 would first close the valves 14 to the stack 15 and/or open the valve 30′. If this action does not sufficiently reduce the measured calorific value, corresponding commands to increase the supply of exhaust gas are given to the heating control unit and to the feed control unit, which are also communicating with each other for avoiding an overheating and/or underheating of the electrically conductive material.

The duct 18 is connected via a valve 41 with the expansion turbine 19 discharging into the atmosphere. When the expansion turbine 19 is driven, generator 23′ is engaged. The gas from the accumulator 11 can also be introduced into a combustion chamber 20. In the embodiment illustrated, the gas turbine 21 drives the axial compressor 22 which supplies compressed air to the combustion chamber 20. The combustion products driving the turbine 21 thus also operate a generator 23 connected thereto.

In another embodiment of the present specification, the exhaust gas is diverted from line 18 to a gas consumer device comprising a synthesis gas burner configured within a combustion furnace-boiler set (not shown) for combustion of the exhaust gas and the generation of steam to drive a steam turbine coupled with a generator for electric power generation. In yet another embodiment of the present specification, exhaust gas is diverted from line 18 to a gas turbine set for generation of electric power, the gas turbine exhaust is diverted to a steam-cycle turbine set for generation of electric power in a combined cycle power configuration. In yet another embodiment of the present specification, the exhaust gas from line 18 is fed into a suitable fuel cell for direct generation of electric power.

In another mode of the present specification, the exhaust gas from line 18 may be deployed and piped to a second reaction plant for conversion of the exhaust gas into Fischer-Tropsch (“F-T”) products, hydrocarbons, commodity chemicals, or derivatives thereof, or combinations thereof.

In one aspect of the present specification, the present specification discloses a method of recovering energy from an electric induction furnace exhaust gas in the gasification of feed fuel to exhaust gas. A gas, especially air or another supply gas is blown onto melt of an electrically conductive material disposed within the electric induction furnace 1 while substantially sealing the electric induction furnace 1 to enable the build-up of a superatmospheric pressure in the furnace 1, wherein the superatmospheric pressure ranges from >1 PSIA to 40 PSIA.

A feed fuel that is pre-sized to a proximate sieve size of between 0.5 and 1.5 mesh is injected into contact with at least a portion of the melt 1c of electrically conductive material. An exhaust gas that is generated within the crucible of the electric induction furnace is withdrawn at a superatmospheric pressure.

The withdrawn electric induction furnace exhaust gas is scrubbed to a proximate temperature range above 90 degrees C. with water in an annular-gap washer 13 with a control member, such as the control valve 12, for varying the pressure differential across a scrubbing gap and thereby controlling the pressure in the furnace 1. The used scrubbing water is piped to a multiplicity of filters 4g for cleaning used scrubbing water to derive cleaned scrubbing water. The cleaned scrubbing water is re-circulated for re-use.

The scrubbed electric induction furnace exhaust gas is stored for subsequent use in the gas accumulator 11. The total calorific value of exhaust gas available for use by a gas consumer device from the accumulator 11 is measured and estimated by a calorific value sensor, such as the calorific value sensor 101. In particular, the measuring and estimating of the total calorific value of exhaust gas may be carried out by an online spectrum analysis, by separating a small stream of exhaust gas out from the accumulator 11 and burning it under a controlled environment or by a combination thereof.

An input of feed fuel, of auxiliary gases and of heating power to the electric induction furnace 1 is adjusted such that the estimated total calorific value of exhaust gas is kept between a pre-determined upper and a pre-determined lower threshold. The adjustment of feed fuel, of auxiliary gases and of heating power to the electric induction furnace 1 is provided by an adjustable controller unit 100, the adjustable controller unit 100 comprising a PD controller. Thereby, a supply to a gas consumer, such as, for example, a gas turbine, an electric generator or a furnace, can be adjusted according to an operating state and specifications of the gas consumer or according to further requirements.

In further embodiments, further process factors are adjusted using the adjustable controller unit, for example by controlling inlets and outlets such as a melt inlet, a slag outlet, a pressurized inlet for keeping an interior of the electric induction furnace under a pre-determined pressure, a cooling water inlet, an exhaust gas inlet, an exhaust gas outlet. In one embodiment, the adjustment of heating power comprises adjustment of a supply of electric power to a heater, in particular to an induction coil. The induction coil may surround the induction furnace, as shown in FIG. 1, or it may also be arranged within the induction furnace.

In another embodiment, the control is realized as a cascaded control in which a heating control unit 103 and a feed control unit 104 are connected to the adjustable controller 100, wherein the heating control unit 103 and the feed control unit are preferentially realized as PID controllers, respectively. According to this embodiment, an output of the adjustable controller unit 100 is used as input for a heating control unit 103 which is provided for adjusting the heating power to the electric induction furnace 1 and an output of the adjustable controller unit 100 is used as an input for a feed control unit 104, which is provided for adjusting the input of feed fuel and the input of auxiliary gases.

According to one embodiment, the value from a calorific value sensor device, such as the calorific sensor device 101, is used to apply ad-hoc control interventions to control heating and supply of the induction furnace elements, wherein supply may refer, among others, to a supply with heating energy, with combustible material such as feed, in particular carbon containing feed, with combustible gas such as oxygen, or also with inert gas, with additives. In one embodiment, the ad-control interventions are carried out as feed-forward control interventions.

For achieving a more fine grained control, a method according to the present specification may furthermore comprise a control of electric actuators of inlet and outlet means, such as the valves 14, the pressure control valve 10a and of the valve 30′, to a duct, such as the duct 40, between the induction furnace and the accumulator by an adjustable controller unit, wherein the electric actuators are controlled according to the measured and estimated calorific value of the exhaust gas.

In another embodiment, to obtain a finer grained control of short and long term supply fluctuations of the exhaust gas, an adjustment of the input to the furnace is controlled by first actuating, with an adjustable controller, electric actuators of inlet valve and outlet valves such as the valves 14, the pressure control valve 10a, and the valve 30′ for short-term ad-hoc adjustments. In case the short term adjustments are not sufficient to achieve a pre-determined target range of an exhaust gas supply and for providing mid- and long-term adjustments a temperature of the molten melt is controlled by sending a signal to a heating control unit and a supply to the crucible is controlled by sending a signal to a feed control unit.

According to one embodiment, a short term adjustment for the case in which the measured calorific value exceeds a pre-determined threshold value comprises opening outlet valves to an outlet, such as a stack, and closing inlet valves of a combustion gas supply, for example by opening the valves 14 to the stack 15 and closing the valve 30′ to the exhaust gas supply “V”. Furthermore, a mid- to long-term adjustment for the case that the measured calorific value exceeds a pre-determined threshold value comprises sending commands to the heating control unit and to the feed control unit for decreasing the supply of exhaust gas. Therein, the heating control unit and the feed control unit are communicating with each other for avoiding an overheating and/or underheating of the electrically conductive material. The abovementioned thresholds values may be different or they may be essentially equal.

According to one embodiment, a short term adjustment for the case in which the measured calorific value falls below a pre-determined threshold value comprises closing outlet valves to an outlet, such as a stack, and opening inlet valves of exhaust gas supply, for example by opening the valves 14 to the stack 15 and close the valve 30′ to the exhaust gas supply “V”, and a mid- to long-term adjustment for the case in which the measured calorific value falls below a pre-determined threshold value comprises sending commands to the heating control unit and to the feed control unit for increasing the supply of exhaust gas. if the measured calorific value falls below a pre-determined threshold value. Therein, the heating control unit and the feed control unit are communicating with each other for avoiding an overheating and/or underheating of the electrically conductive material. The abovementioned thresholds values may be different or they may be essentially equal.

According to one embodiment, the adjustment of the input to the furnace comprises adjustment of a level of the melt/molten material within the crucible, for example by opening and closing of a plug or by adjusting a position of a shutter.

According to another embodiment, the adjustment of the input to the induction furnace comprises adjustment of a current supplied to an induction coil 102 of the induction furnace. According to another embodiment, the adjustment of the input to the induction furnace comprises adjustment of the superatmospheric pressure within the induction furnace by a pump. According to a further embodiment, the adjustment of the input to the induction furnace comprises an adjustment of an amount of feed fuel supplied to the induction furnace. The amount of feed fuel may, in particular, to the inflow of feed fuel per unit of time, wherein the inflow may be averaged. In particular, it may be averaged the opening and closing periods of supply shutters, such as the valves 6a, 6b.

According to yet another embodiment, the adjustment to the input to the induction furnace comprises adjusting an amount of supply gas supplied to the induction furnace, wherein the supply gas is chosen to effect the reaction within the crucible in a desired way.

According to yet another embodiment, the adjustment of the input to the induction furnace comprises adjusting an amount of slag that is withdrawn from the induction furnace such that the estimated total calorific value of exhaust gas is kept between a pre-determined upper and a pre-determined lower threshold, for example by adjusting a position of a stopper at a slag outlet, by adjusting an inclination angle of the crucible, or by adjusting a height of a slag outlet.

According to the present specification, a gas consumer device, such as the combustion chamber 20 and gas turbine 21 is fed with the exhaust gas from the accumulator 11 independently of the blowing periods of the induction furnace. Other consumer devices may include a furnace, a chemical processing plant, a gas turbine or other device for converting the exhaust gas into mechanical energy.

According to one embodiment, the melt in the electric induction furnace (1) is blown with pre-heated air having a temperature range of at least 220 degrees C. for yielding exhaust gas with a high heating value. According to another embodiment the melt mass weight of electrically conductive material is at least 500 kilograms for obtaining a high heat transfer. Specifically, in one embodiment, the melt in the electric induction furnace is blown at a pressure of one or greater than one atmospheres absolute to 40 atmospheres absolute for obtaining a superatmospheric pressure. According to another embodiment, the feed fuel is injected into contact with the melt of electrically conductive material via at least one conduit having an inner diameter of at least 3 inches.

According to another embodiment, the electric induction furnace exhaust gas is mixed, before introduction into the accumulator 11, with a second flow stream of synthesis gas from a remote site having a proximate CO, H.sub.2 gas composition to said exhaust gas or having a second CO, H.sub.2 composition different from that of electric induction furnace exhaust gas. The amount of mixing is controlled by the adjustable controller 100. In FIG. 1, the duct of the admixed gas stream is marked by the letter “V”.

In a further aspect, the present specification discloses a device for recovering energy from an electric induction furnace exhaust gas in the gasification of feed fuel to exhaust gas that comprises a pressurizing means, such as the pump 33 and the valve 34, for blowing or pressurizing melt of an electrically conductive material disposed within an electric induction furnace. The electric induction furnace is substantially sealed to enable the build-up of a superatmospheric pressure in the furnace. Furthermore, a feed supply means, such as the hopper 7 and the gate 6, are provided for injecting feed fuel that is pre-sized to a proximate sieve size of between 0.5 and 1.5 mesh into contact with at least a portion of the melt of electrically conductive material. A means, such as an exhaust duct 40 to the scrubbing unit is provided for withdrawing exhaust gas generated at a superatmospheric pressure from the furnace. A scrubbing means, such as the scrubbing unit 4 with spray nozzles 4a, 4b, upward and downward extending portions 4f and 4g and washing water source 4g and the regulating valve 12 with conical body 12a, ash outlet 12b, cylindrical duct 12c, servo motor 12d, Venturi nozzle 12e and rod 12f, is provided for scrubbing the withdrawn electric induction furnace exhaust gas to a proximate temperature range above 90 degrees C. Therein, an annular-gap washer with a control member, such as the control valve 12, is provided for varying the pressure differential across a scrubbing gap and thereby controlling the pressure in the furnace.

A recirculation means, such as the washing water source 4g, with ducts and recirculation pump that is not shown in FIG. 1, is provided for piping used scrubbing water to a multiplicity of filters and for cleaning the used scrubbing water to derive cleaned scrubbing water. The cleaned scrubbing water is re-circulated for re-use. A gas accumulator is provided for storing the scrubbed electric induction furnace exhaust gas for subsequent use.

Furthermore, a measuring means, such as the calorific value sensor 101, is provided for measuring and estimating the total calorific value of exhaust gas available for use by a gas consumer device from the accumulator. The measuring means is operably connected to an adjustment means for adjusting of feed fuel, of auxiliary gases and of heating power to the electric induction furnace 1 such that the estimated total calorific value of exhaust gas is kept between a pre-determined upper and a pre-determined lower threshold. The adjustment means comprises an adjustable controller unit 100 with a PD controller,

The adjustment means comprises controllable devices for regulating a supply of material or of heating energy to the electric induction furnace, such as, among others, a controllable transport device such as a hopper, a transport belt or other device for pushing the feed in one direction, and/or a means for adjustably limiting an inflow under influence of gravity or pressure, adjustable openings such as valves, airlocks, shutters and similar devices for adjusting the volume stream of the injected feed fuel, and a supply of electric power. An output of the measuring means is used as an input to the adjustable controller unit 100 of the adjustment means such that the estimated total calorific value of exhaust gas is kept between a pre-determined upper and a pre-determined lower threshold.

A consumer supply means, such as the combustion chamber 20 with connected ducts is provided for feeding a gas consumer device, such as the combustion chamber 20 and the gas turbine 21, with the exhaust gas from the accumulator independently of the blowing periods. The device is furthermore configured such that the electric induction furnace exhaust gas is maintained under superatmospheric pressure during the blowing, withdrawing, scrubbing and storing steps without recompression, for example by providing suitable valves, sealing, joints, diameters of tubes, or also pressure meters with feedback control to a pressurization means of the crucible, such as the gas pump 33.

In one embodiment, the adjustment means comprises a cascaded control with a heating controller unit 103 and a feed control unit 104. An input of the heating controller unit 103 is connected to an output of the adjustable controller 100 and an output of the heating controller unit is connected to a supply of heating power, in particular of electric energy, to the electric induction furnace 1. An input of the feed control unit 103 is connected to an output of the adjustable controller 100 and an output of the feed control unit 103 is connected to a supply of feed fuel.

In a further embodiment, the adjustment means comprises controllable valves and a stack, such as valves 14 and stack 15, wherein the stack is connected to a duct between the induction furnace and the accumulator, and the controllable valves are arranged between the stack and the duct. The valves are controlled by an output value of the calorific value sensor.

According to another embodiment, the adjustment means comprises a combustion gas supply, such as the supply “V” of FIG. 1, that is connected to a duct, such as the duct 40. The duct is arranged between the induction furnace and the accumulator and a controllable valve, such as the valve 30′ is arranged between the duct and the combustion gas supply. The controllable valve is controlled by an output value of the calorific value sensor.

According to another embodiment, the adjustment means comprises a reservoir for the melt/molten material, such as the reservoir 1b, and an adjustable stopper which is controlled by the adjustable stopper 1d that is controlled by an output of the adjustable controller 100, and, if provided, by the heating control unit 103.

According to another embodiment, the adjustment means comprises a gas feed, such as the pipes 2a, 2b with an adjustable valve. The adjustable valve is controlled by the adjustable controller 100 and, if provided, by the feed control unit 104 by closing, opening or adjusting a degree of valve opening according to control signals.

According to another embodiment, the adjustment means comprises a feed transportation unit with adjustable elements, such as the valves 6a, 6b or, for example, shutters, movable walls, airlocks, impellers or conveyer belt, wherein the adjustable elements are operable to control a feed flow of the feed and are controlled by an output value of the calorific value sensor. The adjustable elements are controlled by the adjustable controller and, if provided, by the feed controller unit 104.

According to another embodiment, the adjustment means comprises a slag drain with an adjustable stopper, such as the stopper 8a, that is controlled by an output value of the calorific value sensor. The adjustable stopper is controlled by the adjustable controller 100 and, if provided by the heating control unit 103.

The electric induction furnace exhaust gas under is maintained under superatmospheric pressure during the blowing, withdrawing, scrubbing and storing steps without recompression, for example by suitable sealing of the processing space, design of the duct sizes or also by controlling an input to the induction furnace, for example by providing pressure gauges which are connected to a controller for controlling the input to the induction furnace.

The subject of the present specification can also be described with the following lists of elements being organized into items. The respective combinations of features which are disclosed in the item list are regarded as independent subject matter, respectively, that can also be combined with other features of the application.

1. An electric induction furnace that is packaged in at least two 40-foot ISO containers for easier transport to a site, for example by providing a power supply in one container and the crucible in another container. By way of example, the ISO containers may be used for temporary installations on industrial sites or waste sites or for installations in remote locations.

2. An electric induction furnace in which the exhaust gas composition is adjusted such that the gas consumer device 20, 21 receives exhaust gas having a CO composition of at least 20 wt % (weight percent) from the accumulator 11 to convert at least a portion of exhaust gas to electrical power, one or more Fischer-Tropsch products, carbon dioxide, hydrogen, derivatives thereof, or combinations thereof. In one embodiment, the calorific value sensor and the controller are used to control inputs to the induction furnace for providing an exhaust gas with approximately the abovementioned content of CO.

3. At least two coreless induction furnaces each are configured in a set of 2 40-foot ISO containers and operatively linked to a gas accumulator; wherein each of at least two said furnaces are adapted to be substantially sealed and each of at least two furnaces having at least 500 kilograms of an electrically conductive material disposed within, comprising the following steps:

blowing melt of electrically conductive material disposed within each coreless induction furnace to enable the build-up of a superatmospheric pressure of between 1 to 40 pressure absolute in said furnace with air that is pre-heated to at least 220 degrees C.;

injecting feed fuel pre-sized to a proximate sieve size of 20 millimeters at a feed rate of at least 10 kilograms per minute into contact with at least a portion of the melt of electrically conductive material in each coreless induction furnace;

withdrawing exhaust gas generated at a superatmospheric pressure from each said furnace;

varying the feed rate, blowing velocity, blowing pressure of either first coreless induction furnace or second coreless induction furnace to adjust the CO composition of the exhaust gas withdrawn from either first, second coreless induction furnace, or combinations thereof to control the CO composition of exhaust gas stored in the accumulator to have at least 30 wt. % CO;

scrubbing the withdrawn exhaust gas from each said furnace to a proximate temperature range above 90 degrees C. with water in an annular-gap washer having a control member for varying the pressure differential across a scrubbing gap and thereby controlling the pressure in each said furnace; and

piping used scrubbing water to a multiplicity of filters for cleaning used scrubbing water to derive cleaned scrubbing water wherein cleaned scrubbing water is re-circulated for re-use;

storing the scrubbed exhaust gas for subsequent use in gas accumulator; measuring and estimating the total calorific value of exhaust gas available for use by a gas consumer device from accumulator;

feeding a gas consumer device with the exhaust gas from said accumulator independently of the blowing periods; and

maintaining both the coreless induction furnace exhaust gas under superatmospheric pressure during the blowing, withdrawing, scrubbing and storing steps without recompression.

4. A coreless induction furnace configured to conduct gasification of one or more feed fuel to synthesis gas having a CO composition of at least 30 wt % with a supporting structure adapted to hold at least one induction coil that surrounds a crucible of the furnace; the at least one induction coil is arranged with a hollow conduit to allow passage of a cooling fluid from at least one induction coil to a water-cooled condenser unit configured to regulate the operating temperature of the at least one induction coil once energized with ac power provided from a power supply unit; the crucible, supporting structure, water-cooled condenser unit and power supply unit configured and arranged in one or more containerized packages or ISO containers; wherein each of one or more said ISO containers is adapted with one or more ventilation apertures to allow for sufficient air flow during the operation of coreless induction furnace; and coreless induction furnace is substantially sealed and closed and configured with at least one conduit device having one or more passages to allow one or more feed fuel to flow from at least one conduit device into contact with an electrically conductive melt disposed within the crucible of said furnace; the at least one conduit device adapted with a multiplicity of channels to allow the flow of a coolant gas or liquid to regulate the temperature of said at least one conduit device; crucible is configured to hold at least 500 kilograms of electrically conductive melt and has at least one tubular apparatus to allow withdrawal of melted slag to flow from crucible to a remote site; coreless induction furnace also configured to have an exhaust duct device with a multiplicity of sensors for measuring the superficial gas velocity, gas pressure, gas temperature, or combinations thereof of the synthesis gas generated therefrom; wherein at least one conduit device is configured to cause one or more feed fuel to flow at a rate of at least 35 kilograms per minute into contact with electrically conductive melt.

That which is claimed is:

1. A method of recovering energy from an electric induction furnace exhaust gas in the gasification of feed fuel to exhaust gas, comprising the steps of:
blowing onto a melt (1c) of an electrically conductive material disposed within the electric induction furnace (1) while substantially sealing the electric induction furnace (1) to enable the build-up of a superatmospheric pressure in the furnace (1);
injecting feed fuel pre-sized to a proximate sieve size of between 0.5 and 1.5 mesh into contact with at least a portion of the melt (1c) of electrically conductive material;
withdrawing exhaust gas generated at a superatmospheric pressure from said furnace (1);
scrubbing the withdrawn electric induction furnace exhaust gas to a proximate temperature range above 90 degrees C. with water in an annular-gap washer (13) having a control member (12) for varying the pressure differential across a scrubbing gap and thereby controlling the pressure in said furnace (1); and
piping used scrubbing water to a multiplicity of filters (4g) for cleaning used scrubbing water to derive cleaned scrubbing water wherein cleaned scrubbing water is re-circulated for re-use; storing the scrubbed electric induction furnace exhaust gas for subsequent use in a gas accumulator (11);
measuring and estimating the total calorific value of exhaust gas available for use by a gas consumer device from the accumulator (11);
adjusting an input of feed fuel, of auxiliary gases and of heating power to the electric induction furnace (1) such that the estimated total calorific value of exhaust gas is kept between a pre-determined upper and a pre-determined lower threshold, wherein the adjusting of feed fuel, of auxiliary gases and of heating power to the electric induction furnace (1) is provided by an adjustable controller unit (100), the adjustable controller unit (100) comprising a PD controller;
feeding a gas consumer device (20, 21) with the exhaust gas from the accumulator (11) independently of the blowing periods; and maintaining the electric induction furnace exhaust gas under superatmospheric pressure during the blowing, withdrawing, scrubbing and storing steps without recompression.

2. Method according to claim 1, wherein the measuring and estimating the total calorific value of exhaust gas comprises an online spectrum analysis or separating a pre-determined pre-determined stream of exhaust gas out from the accumulator (11) and burning it under a controlled environment or a combination thereof.

3. Method according to claim 1, comprising
using an output of the adjustable controller unit (100) as input for a heating control unit (103), the heating control unit (103) being provided for adjusting the heating power to the electric induction furnace (1),
using an output of the adjustable controller unit (100) as input for a feed control unit (104), the feed control unit (104) being provided for adjusting the input of feed fuel and the input of auxiliary gases.

4. Method according to claim 1, wherein the value from the calorific value sensor device (101) is used to apply ad-hoc control interventions to control heating and supply of the induction furnace elements.

5. Method according to claim 1, wherein adjusting the input to the furnace (1) comprises actuating electric actuators of inlet valve and outlet valves for short-term adjustments; and
controlling a temperature of the molten melt and controlling a supply to the crucible for mid- and long-term adjustments.

6. Method according to claim 5, wherein the short-term adjustments comprise opening outlet valves and closing inlet valves if the measured calorific value exceeds a pre-determined threshold value, and wherein the mid- and long-term adjustments comprise sending commands to the heating control unit and to the feed control unit for decreasing the supply of exhaust gas if the measured calorific value exceeds a pre-determined threshold value.

7. Method according to claim 5, wherein the short-term adjustments comprise closing outlet valves and opening inlet if the measured calorific value falls below a pre-determined threshold value, and wherein the mid- to long-term adjustments comprise sending commands to the heating control unit and to the feed control unit for increasing the supply of exhaust gas if the measured calorific value falls below a pre-determined threshold value.

8. Method according to claim 1, wherein the adjustment of the input to the furnace (1) comprises adjustment of a level of melt/molten material.

9. Method according to claim 1, wherein the adjustment of the input to the induction furnace (1) comprises adjustment of a current supplied to an induction coil (102) of the induction furnace (1).

10. Method according to claim 1, wherein the adjustment of the input to the induction furnace (1) comprises adjustment of the superatmospheric pressure within the induction furnace (1) by a pump.

11. Method according to claim 1, comprising adjusting an amount of slag withdrawn from the induction furnace such that the estimated total calorific value of exhaust gas is kept between a pre-determined upper and a pre-determined lower threshold.

12. The method according to claim 1 wherein the melt in the electric induction furnace (1) is blown with pre-heated air having a temperature range of at least 220 degrees C. for yielding exhaust gas with a high heating value.

13. The method according to claim 1 wherein feed fuel is injected into contact with the melt of electrically conductive material via at least one conduit having an inner diameter of at least 3 inches.

14. The method according to claim 1 wherein the electric induction furnace exhaust gas before introduction into the accumulator is mixed with a second flow stream of synthesis gas from a remote site having a proximate CO, H.sub.2 gas composition to said exhaust gas or having a second CO, H.sub.2 composition different from that of electric induction furnace exhaust gas.

15. Device for recovering energy from an electric induction furnace exhaust gas in the gasification of feed fuel to exhaust gas, comprising:
pressurizing means (33, 44) for blowing melt of an electrically conductive material disposed within electric induction furnace (1), the electric induction furnace (1) being substantially sealed to enable the build-up of a superatmospheric pressure in the furnace (1);
feed supply means (7, 6) for injecting feed fuel pre-sized to a proximate sieve size of between 0.5 and 1.5 mesh into contact with at least a portion of the melt (1c) of electrically conductive material;
means (4) for withdrawing exhaust gas generated at a superatmospheric pressure from said furnace (1);
scrubbing means (4, 12) for scrubbing the withdrawn electric induction furnace exhaust gas to a proximate temperature range above 90 degrees C. with water in an annular-gap washer (13) having a control member (12) for varying the pressure differential across a scrubbing gap and thereby controlling the pressure in said furnace (1); and
recirculation means (4g) for piping used scrubbing water to a multiplicity of filters (4g) for cleaning used scrubbing water to derive cleaned scrubbing water wherein cleaned scrubbing water is re-circulated for re-use; storing the scrubbed electric induction furnace exhaust gas for subsequent use in a gas accumulator (11);
measuring means (101) for measuring and estimating the total calorific value of exhaust gas available for use by a gas consumer device from the accumulator (11),
adjustment means for adjusting of feed fuel, of auxiliary gases and of heating power to the electric induction furnace (1) such that the estimated total calorific value of exhaust gas is kept between a pre-determined upper and a pre-determined lower threshold, the adjustment means comprising an adjustable controller unit (100), the adjustable controller unit (100) comprising a PD controller,
consumer supply means for feeding a gas consumer device with the exhaust gas from the accumulator (11) independently of the blowing periods; and maintaining the electric induction furnace exhaust gas under superatmospheric pressure during the blowing, withdrawing, scrubbing and storing steps without recompression.

16. Device for recovering energy from an electric induction furnace exhaust gas according to claim 15, comprising a heating controller unit (103) and a feed control unit (104), an input of the heating controller unit (103) being connected to an output of the adjustable controller (100) and an output of the heating controller unit being connected to a supply of heating power to the electric induction furnace (1), an input of the feed control unit (103) being connected to an output of the adjustable controller (100) and an output of the feed control unit (103) being connected to a supply of feed fuel.

17. Device for recovering energy from an electric induction furnace exhaust gas according to claim 15, wherein the adjustment means comprises controllable valves (14), the controllable valves (14) being controlled by the adjustable controller (100) and a stack (15), the stack (15) being connected to a duct (40) between the induction furnace (1) and the accumulator, the controllable valves (14) being arranged between the stack (15) and the duct (40).

18. Device for recovering energy from an electric induction furnace exhaust gas according to claim 15, wherein the adjustment means comprises a combustion gas supply “V” that is connected to a duct (40), the duct (40) being arranged between the induction furnace (1) and the accumulator (11), and a controllable valve (30′) that is controlled by the adjustable controller (100), the controllable valve (30′) being arranged between the duct (40) and the combustion gas supply “V”.

19. Device for recovering energy from an electric induction furnace exhaust gas according to claim 15, wherein the adjustment means comprises a reservoir (1b) for the melt and an adjustable stopper (1d), the adjustable stopper (1d) being controlled by the adjustable controller (100).

20. Device for recovering energy from an electric induction furnace exhaust gas according to claim 15, wherein the adjustment means comprises a gas feed (2a, 2b) with an adjustable valve, the adjustable valve being controlled by the adjustable controller (100).
